(19) United States
(12) Patent Application Publication
(10) Pub. No.: US 2026/0291852 A1
(43) Pub. Date: Sep. 24, 2026

(54) USER-PREFERENCE BASED USER-SPECIFIC ROUTING DATA GENERATION

(71) Applicant: International Business Machines Corporation, Armonk, NY (US)

(72) Inventors: Vidhya Balasubramanian, Kanchipuram (IN); Siddhartha Sood, Ghaziabad (IN); Abhishek Jain, Baraut (IN); Uma Kumari Korukonda, Hyderabad (IN); Jayashree ., Bangalore (IN); MEGHANA M KULKARNI, Pune (IN)

(21) Appl. No.: 19/082,442

(22) Filed: Mar. 18, 2025

(51) Int. Cl. H04L 45/12; H04L 41/0894; H04L 45/00

(52) U.S. Cl. CPC H04L 45/124; H04L 41/0894; H04L 45/14

(57) ABSTRACT

Generation of user-specific routing data includes receiving user-preference data associated with a user and request data associated with a routing operation. The user-preference data indicates sustainable routing condition data or unsustainable routing condition data. The request data includes message data for the routing operation and destination data associated with a destination of the routing operation. Routing zone data is determined based on the request data. The routing zone data indicates routing zones for the routing operation, latency data associated with the routing zones, or sustainability score data associated with the routing zones. User-specific routing data is generated for the routing operation based on the routing zone data and the user-preference data. The user-specific routing data indicates a routing zone of the one or more routing zones. The user-specific routing data is output.

### BACKGROUND

The disclosure relates to routing data generation and more particularly to sustainable routing data generation.

Sustainable routing refers to the optimization of data transmission routes in network communications to minimize energy consumption. As a result, sustainable routing may mitigate environmental impacts associated with network operations. Sustainable routing integrates energy efficiency into routing protocols and algorithms, facilitating real-time adaptation to dynamic network conditions and varying traffic patterns. By considering the energy consumption of network devices, sustainable routing enhances the energy efficiency of data transmission. Data centers may leverage sustainable routes to manage data transmission paths, ensuring high performance with lower energy usage. Additionally, Internet of Things (IoT) networks may use the sustainable routing to extend battery life of interconnected devices through optimized data paths.

### SUMMARY

In various embodiments of the disclosure, a computer-implemented method for user-preference based user-specific routing data generation is described. The computer-implemented method includes receiving, by a computer, user-preference data associated with a user. The user-preference data indicates at least one of sustainable routing condition data, or unsustainable routing condition data. The computer-implemented method further includes receiving, by the computer, request data associated with a routing operation. The request data is received from a user device associated with the user. The request data includes message data for the routing operation and destination data associated with a destination of the routing operation. The computer-implemented method further includes determining, by the computer, routing zone data based on the request data. The routing zone data indicates at least one of one or more routing zones for the routing operation, latency data associated with each routing zone of the one or more routing zones, or sustainability score data associated with each routing zone of the one or more routing zones. The computer-implemented method further includes generating, by the computer, user-specific routing data for the routing operation. The user-specific routing data indicates at least one routing zone of the one or more routing zones. The user-specific routing data is generated based on the routing zone data and the user-preference data. The computer-implemented method further includes outputting, by the computer, the user-specific routing data.

In various embodiments of the disclosure, a computer system for user-preference based user-specific routing data generation is described.

In various embodiments of the disclosure, a computer-program product for user-preference based user-specific routing data generation is described.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for generation of user-preference based user-specific routing data, in accordance with an embodiment of the disclosure;

FIG. 2 is a diagram that illustrates an environment for the generation of the user-preference based user-specific routing data, in accordance with an embodiment of the disclosure;

FIG. 3A is a diagram that illustrates exemplary operations for generation of sustainable routing policies, in accordance with an embodiment of the disclosure;

FIG. 3B is a diagram that illustrates exemplary operations for generating user-specific routing data, in accordance with an embodiment of the disclosure;

FIG. 4 is a diagram that illustrates an exemplary flowchart of a method for identifying a routing zone, in accordance with an embodiment of the disclosure;

FIG. 5A is a diagram that illustrates exemplary operations for generating transmission data, in accordance with an embodiment of the disclosure;

FIG. 5B is a diagram that illustrates an exemplary first user interface for validation of the user-specific routing data, in accordance with an embodiment of the disclosure;

FIG. 5C is a diagram that illustrates a sequence diagram for transmitting transmission data to a destination based on the user-specific routing data, in accordance with an embodiment of the disclosure;

FIG. 6 is a diagram that illustrates a flowchart of a method for updation of validation request, in accordance with an embodiment of the disclosure;

FIG. 7 is a diagram that illustrates exemplary operations for generating workload threshold data, in accordance with an embodiment of the disclosure; and

FIG. 8 is a diagram that illustrates a flowchart of an exemplary method for generation of the user-preference based user-specific routing data, in accordance with an embodiment of the disclosure.

### DETAILED DESCRIPTION

In today's digital landscape, the rapid increase in network traffic has increased the carbon footprint associated with data transmission and network operations. As more devices connect to the internet and data consumption escalates, the environmental impact of these activities becomes increasingly significant.

Current sustainable routing strategies primarily emphasize consumer experience, often prioritizing non-functional requirements, such as latency, throughput, and reliability. However, the non-functional requirements are crucial for ensuring user satisfaction and optimal network performance. These non-functional requirements may get neglected due to the environmental implications associated with network operations when opting for sustainable routing.

The existing latency-based routing approaches tend to focus solely on minimizing delays and maximizing data transfer speeds, thereby overlooking the significant opportunity to optimize energy consumption and reduce carbon emissions. The latency-based routing approaches fail to reduce energy consumption and carbon emissions, which are essential for fostering a more sustainable network infrastructure. Therefore, there is a need for the development of sustainable routing strategies. In addition, existing routing-approaches fail to involve users in the decision-making process for deciding routing strategy as per user's existing needs. There is a need for user involvement in the decision-making process to effectively minimize the carbon footprint associated with network operations.

Accordingly, the present disclosure discloses techniques for generating user-specific routing data based on user preference. The user-specific routing data is used for routing data packets from a user device associated with a user to a destination based on user preferences. In this regard, when the user selects sustainable routing policies, the data packets are routed through sustainable routes or routing paths enabling the user to control or balance the non-functional requirements for the routing operation. In an example, enabling the users to take an active role in routing decisions can significantly enhance the overall effectiveness of sustainability initiatives without affecting user experience detrimentally. By fostering a sense of responsibility among users regarding their impact on the global carbon footprint, it becomes possible to create a more collaborative approach to energy consumption and resource management.

In various embodiments of the disclosure, a computer-implemented method for user-preference based user-specific routing data generation is described. The computer-implemented method includes receiving, by a computer, user-preference data associated with a user. The user-preference data indicates at least one of sustainable routing condition data or unsustainable routing condition data. The computer-implemented method further includes receiving, by the computer, request data associated with a routing operation. The request data is received from a user device associated with the user. The request data includes message data for the routing operation and destination data associated with a destination of the routing operation. The computer-implemented method further includes determining, by the computer, routing zone data based on the request data. The routing zone data indicates at least one of one or more routing zones for the routing operation, latency data associated with each routing zone of the one or more routing zones, or sustainability score data associated with each routing zone of the one or more routing zones. The computer-implemented method further includes generating, by the computer, user-specific routing data for the routing operation. The user-specific routing data indicates at least one routing zone of the one or more routing zones. The user-specific routing data is generated based on the routing zone data and the user-preference data. The computer-implemented method further includes outputting, by the computer, the user-specific routing data.

In various embodiments of the disclosure, the computer-implemented method further includes retrieving, by the computer, policy data associated with a plurality of routing policies. The computer-implemented method further includes configuring, by the computer, one or more sustainable routing policies based on the policy data and the user-preference data. The computer-implemented method further includes outputting, by the computer, the one or more sustainable routing policies.

In various embodiments of the disclosure, the sustainable routing condition data indicates a workload threshold data for implementing a specific sustainable routing policy of the one or more sustainable routing policies.

In various embodiments of the disclosure, the computer-implemented method further includes analyzing, by the computer, the routing zone data based on the workload threshold data. The computer-implemented method further includes identifying, by the computer, a sustainable routing zone of the one or more routing zones based on the analysis. The sustainable routing zone is associated with the specific sustainable routing policy. The computer-implemented method further includes generating, by the computer, the user-specific routing data based on the sustainable routing zone and the specific sustainable routing policy.

In various embodiments of the disclosure, for analyzing the routing data based on the workload threshold data, the computer-implemented method further includes comparing, by the computer, at least one of the latency data associated with each routing zone of the one or more routing zones or the sustainability score data associated with each routing zone of the one or more routing zones with the workload threshold data. The computer-implemented method further includes determining, by the computer, at least one of the latency data or the sustainability score data associated with the sustainable routing zone meets the workload threshold data based on the comparison. The computer-implemented method further includes controlling, by the computer, an execution of the routing operation based on the determination.

In various embodiments of the disclosure, the computer-implemented method further includes training, by the computer, an artificial intelligence (AI) model based on the user-preference data. The computer-implemented method further includes generating, by the computer, the workload threshold data based on the trained AI model.

In various embodiments of the disclosure, the computer-implemented method further includes generating, by the computer, a validation request for a validation of the user-specific routing data. The computer-implemented method further includes transmitting, by the computer, the validation request to a user device associated with the user. The computer-implemented method further includes receiving, by the computer, validation data based on the transmitted validation request. The computer-implemented method further includes generating, by the computer, transmission data for the routing operation. The generation of the transmission data is based on the validation data, and the transmission data includes the request data and the user-specific routing data.

In various embodiments of the disclosure, the computer-implemented method further includes transmitting, by the computer, the transmission data to a routing entity. The computer-implemented method further includes controlling, by the computer, the routing entity to execute the routing operation. The routing operation is executed to transmit the message data to the destination based on the user-specific routing data, and the routing entity is controlled based on the transmitted transmission data.

In various embodiments of the disclosure, the computer-implemented method further includes determining, by the computer, a user emission score associated with the execution of the routing operation. The computer-implemented method further includes comparing, by the computer, the user emission score with an emission threshold. The computer-implemented method further includes updating, by the computer, the user-specific routing data based on the comparison of the user emission score with the emission threshold. The computer-implemented method further includes updating, by the computer, the validation request for a validation of the updated user-specific routing data.

In various embodiments of the disclosure, each routing zone of the one or more routing zones is associated with at least one compute resource.

In various embodiments of the disclosure, the computer-implemented method further includes obtaining, by the computer, a first latency and a first sustainability score associated with a first routing zone of the one or more routing zones. The computer-implemented method further includes obtaining, by the computer, a second latency and a second sustainability score associated with a second routing zone of the one or more routing zones. The computer-implemented method further includes comparing, by the computer, each of the first latency with the second latency, and the first sustainability score with the second sustainability score. The computer-implemented method further includes identifying, by the computer, a specific routing zone from the first routing zone and the second routing zone for the routing operation. The specific routing zone is identified based on the comparison and the user-preference data. The computer-implemented method further includes generating, by the computer, the user-specific routing data based on the identification.

In various embodiments of the disclosure, a computer system for user-preference based user-specific routing data generation is described. The computer system includes a processor set, one or more computer-readable storage media, and program instructions stored on the one or more computer-readable storage media. The program instructions are executable by the processor set and cause the processor set to receive user-preference data associated with a user. The user-preference data indicates at least one of sustainable routing condition data or unsustainable routing condition data. The program instructions further cause the processor set to receive request data associated with a routing operation. The request data is received from a user device associated with the user, and the request data includes message data for the routing operation and destination data associated with a destination of the routing operation. The program instructions further cause the processor set to determine routing zone data based on the request data. The routing zone data indicates at least one of one or more routing zones for the routing operation, latency data associated with each routing zone of the one or more routing zones, or sustainability score data associated with each routing zone of the one or more routing zones. The program instructions further cause the processor set to generate user-specific routing data for the routing operation. The user-specific routing data indicates at least one routing zone of the one or more routing zones, and the user-specific routing data is generated based on the routing zone data and the user-preference data. The program instructions further cause the processor set to output the user-specific routing data.

In various embodiments of the disclosure, the program instructions cause the processor set to retrieve policy data associated with a plurality of routing policies. The program instructions further cause the processor set to configure one or more sustainable routing policies based on the policy data and the user-preference data. The program instructions further cause the processor set to output the one or more sustainable routing policies.

In various embodiments of the disclosure, the sustainable routing condition data indicates a workload threshold data for implementing a specific sustainable routing policy of the one or more sustainable routing policies.

In various embodiments of the disclosure, the program instructions further cause the processor set to analyze the routing zone data based on the workload threshold data. The program instructions further cause the processor set to identify a sustainable routing zone of the one or more routing zones based on the analysis. The sustainable routing zone is associated with the specific sustainable routing policy. The program instructions further cause the processor set to generate the user-specific routing data based on the sustainable routing zone and the specific sustainable routing policy.

In various embodiments of the disclosure, to analyze the routing zone data based on the workload threshold data, the program instructions cause the processor set to compare at least one of the latency data associated with each zone of the one or more routing zones or the sustainability score data associated with each zone of the one or more routing zones with the workload threshold data. The program instructions further cause the processor set to determine at least one of the latency data or the sustainability score data associated with the sustainable routing zone meets the workload threshold data based on the comparison. The program instructions further cause the processor set to control an execution of the routing operation based on the determination.

In various embodiments of the disclosure, the program instructions further cause the processor set to train, by the computer, an artificial intelligence (AI) model based on the user-preference data. The program instructions further cause the processor set to generate the workload threshold data based on the trained AI model.

In various embodiments of the disclosure, the program instructions further cause the processor set to generate a validation request for a validation of the user-specific routing data. The program instructions further cause the processor set to transmit the validation request to a user device associated with the user. The program instructions further cause the processor set to receive validation data in response to the validation request. The program instructions further cause the processor set to generate transmission data for the routing operation. The generation of the transmission data is based on the validation data, and the transmission data includes the request data and the user-specific routing data.

In various embodiments of the disclosure, the program instructions further cause the processor set to transmit the transmission data to a routing entity. The program instructions further cause the processor set to control the routing entity to execute the routing operation. The routing operation is executed to transmit the message data to the destination based on the user-specific routing data, and the routing entity is controlled based on the transmitted transmission data.

In various embodiments of the disclosure, a computer-program product for generation of user-preference based user-specific routing data is described. The computer program product includes one or more computer-readable storage media and program instructions stored on the one or more computer-readable storage media to perform operations. The operations include receiving user-preference data associated with a user. The user-preference data indicates at least one of sustainable routing condition data or unsustainable routing condition data. The operations further include receiving request data associated with a routing operation. The request data is received from a user device associated with the user, and the request data includes message data for the routing operation and destination data associated with a destination of the routing operation. The operations further include determining routing zone data based on the request data. The routing zone data indicates at least one of one or more routing zones for the routing operation, latency data associated with each routing zone of the one or more routing zones, or sustainability score data associated with each routing zone of the one or more routing zones. The operations further include generating user-specific routing data for the routing operation. The user-specific routing data indicates at least one routing zone of the one or more routing zones, and the user-specific routing data is generated based on the routing zone data and the user-preference data. The operations further include outputting the user-specific routing data.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

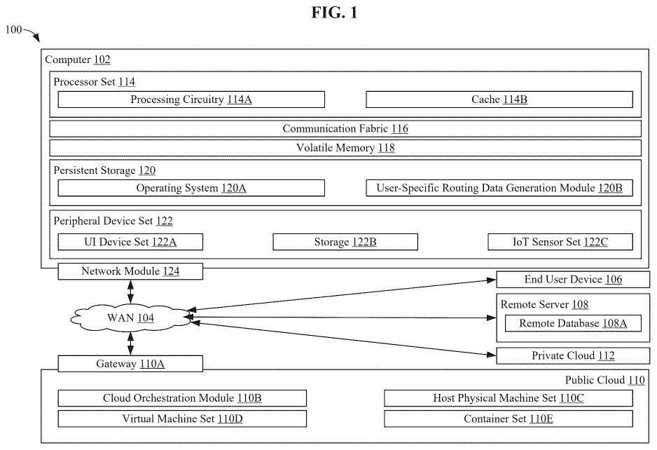

FIG. 1 is a diagram that illustrates a computing environment for generation of user-preference based user-specific routing data. With reference to FIG. 1, there is shown a computing environment 100 that contains an example of an environment for the execution of at least some of the computer code involved in performing the disclosed methods, such as a user-specific routing data generation module 120B. In addition to the user-specific routing data generation module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the user-specific routing data generation module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or a wearable computer, a mainframe computer, a quantum computer, or any various forms of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. In this presentation of the computing environment 100, detailed discussion is focused on a single computer, specifically the computer 102, to keep the presentation as simple as possible. The computer 102 may be located in a cloud, even though it is not shown in a cloud in FIG. 1. The computer 102 is not required to be in a cloud except to any extent as is affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus performed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods may be stored in the dynamic modification of the user-specific routing data generation module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The storage 122B is any type of volatile memory now known or to be developed in the future. Examples include dynamic type random access memory (RAM) or static type RAM. Typically, the storage 122B is characterized by random access, but this is not required unless affirmatively indicated. In the computer 102, the storage 122B is located in a single package and is internal to computer 102, but alternatively or additionally, the storage 122B may be distributed over multiple packages and/or located externally with respect to computer 102.

The volatile memory 118 is any type of volatile memory now known or to be developed in the future. Examples include dynamic type random access memory (RAM) or static type RAM. Typically, the volatile memory 118 is characterized by random access, but this is not needed unless affirmatively indicated. In the computer 102, the volatile memory 118 is located in a single package and is internal to the computer 102, but alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the user-specific routing data generation module 120B typically includes at least some of the computer code involved in performing the disclosed methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

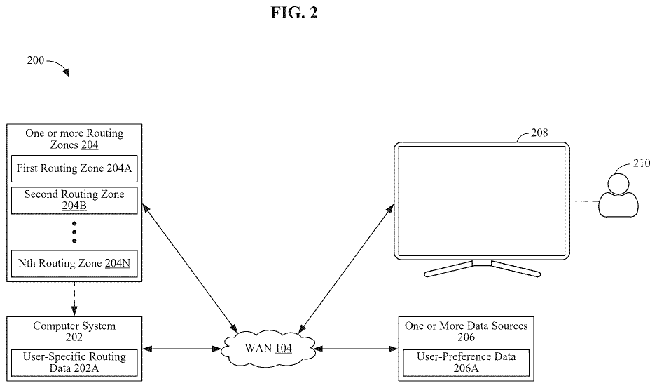

FIG. 2 is a diagram that illustrates an environment generation of user-preference based user-specific routing data, in accordance with an embodiment of the disclosure. FIG. 2 is explained in conjunction with elements from FIG. 1. With reference to FIG. 2, there is shown a diagram of a network environment 200. The network environment 200 includes a computer system 202, and one or more routing zones 204. The one or more routing zones 204 may include a first routing zone 204A, a second routing zone 204B, up to an Nth routing zone 204N. The network environment 200 further includes one or more data sources 206 that may collect or store user-preference data 206A. Further, the network environment 200 may include a user device 208 associated with a user 210. The network environment 200 further includes the WAN 104 of FIG. 1. In an embodiment of the disclosure, the user device 208 is an exemplary embodiment of the EUD 106. Similarly, the computer system 202 is an exemplary embodiment of the computer 102 in FIG. 1.

The computer system 202 includes suitable logic, circuitry, and/or interfaces for determining a sustainable routing zone of the one or more routing zones 204. The computer system 202 determines the one or more routing zones 204 based on the user-preference data 206A. The computer system 202 receives the user-preference data 206A from the user device 208 associated with the user 210. The user-preference data 206A indicates at least one of sustainable routing condition data, or unsustainable routing condition data. The computer system 202 receives request data associated with a routing operation. The request data is received from the user device 208 associated with the user 210. The computer system 202 determines routing data based on the request data. The routing data indicates at least one of the one or more routing zones 204 for executing the routing operation, latency data associated with each zone of the one or more routing zones 204, or sustainability score data associated with each zone of the one or more routing zones 204. The computer system 202 generates user-specific routing data 202A for executing the routing operation. The user-specific routing data 202A is determined based on the routing data and the user-preference data 206A. The computer system 202 outputs the user-specific routing data 202A.

Examples of the computer system 202 include but are not limited to, a server, a computing device, a virtual computing device, a mainframe machine, a computer workstation, a smartphone, a cellular phone, a mobile phone, a gaming device, or a consumer electronic (CE) device. By way of example, and not by limitation, the computer system 202 may be embodied as a cloud-based service, a cloud-based application, a cloud-based platform, a remote server-based service, a remote server-based application, a remote server-based platform, or a virtual computing system.

The one or more routing zones 204 are defined as distinct, geographically separated data center facilities within a cloud service provider's infrastructure that are designed to operate independently while remaining interconnected through high-speed, low-latency networks. Each routing zone of the one or more routing zones 204 is equipped with its own power supply, cooling systems, and physical security measures, ensuring that a failure in one zone does not impact the operations of another. This architectural design enables users to deploy applications and services across multiple routing zones, thereby enhancing fault tolerance, improving disaster recovery capabilities, and ensuring high availability of services. The one or more routing zones 204 may be working on sustainable routing on their energy sourcing and sustainability practices.

By way of example, and not by limitation, the one or more routing zones 204 include the first routing zone 204A, the second routing zone 204B, up to the Nth routing zone 204N. In a scenario, the user 210 is using an application (an e-commerce website) associated with an enterprise. The enterprise has four servers across a country “X”. A first server is located at a first location, a second server is located at a second location, a third server is located at a third location, and a fourth server is located at a fourth location. Further, the first location, the second location, the third location, and the fourth location are located within the country “X”. The user 210 initiates a request associated with a purchase of a product from the application using the user device 208. In an embodiment, if the computer system 202 routes the request to the first server located at the first location, then a path via which the request is routed from the computer system 202 to the first server will be the first routing zone 204A. In an embodiment, if the computer system 202 routes the request to the second server located at the second location, then a path via which the request is routed from the computer system 202 to the second server will be the second routing zone 204B. In an embodiment, if the computer system 202 routes the request to the third server located at the third location, then a path via which the request is routed from the computer system 202 to the third server will be the third routing zone. In an embodiment, if the computer system 202 routes the request to the fourth server located at the fourth location, then a path via which the request is routed from the computer system 202 to the fourth server will be the fourth routing zone.

Each data source of the one or more data sources 206 corresponds to an organized collection of data that may be stored and accessed electronically from a computer system (such as the computer system 202). Each of the one or more data sources 206 may be designed to manage, store, retrieve, and update data efficiently. In an exemplary implementation, each data source of the one or more data sources 206 may correspond to a database. In such an implementation, the structure of the database corresponding to each data source of the one or more data sources 206 typically involves tables, records, and fields that can be managed through various database management systems (DBMS). Examples of each data source of one or more data sources 206 may include but are not limited to, a relational database, a Non-Structured Query Language (SQL) database, a hierarchical database, a network database, a transactional database, a data warehouse, and a distributed database.

The user device 208 includes suitable logic, circuitry, and/or interfaces that are configured to execute one or more tasks. The user device 208 performs the one or more tasks such as receiving data, processing the data, and transmitting the data. The user device 208 includes a central processing unit (CPU) and a memory unit. Examples of the user device 208 include one but are not limited to, a computer workstation, a laptop, a smartphone, a cellular phone, a mobile phone, a consumer electronic (CE) device, an Internet of Things (IoT) device, a computing device, and the like.

In operation, the computer system 202 is configured to receive the user-preference data 206A associated with the user 210. The computer system 202 may receive the user-preference data 206A from the user device 208 associated with the user 210. The user-preference data 206A indicates at least one of sustainable routing condition data, or unsustainable routing condition data. The sustainable routing condition data includes conditions that define sustainable routing. The sustainable routing refers to a network routing methodology that optimizes path selection for data transmission based on environmental and energy efficiency criteria, in addition to traditional performance metrics such as latency and bandwidth. The sustainable routing allows the selection of routing zones that have cloud resources running on sustainable resources such as wind energy, solar energy, hydropower, and the like.

Similarly, the unsustainable routing condition data includes conditions that define unsustainable routing. The unsustainable routing refers to a network routing methodology that operates based on non-functional requirements (NFR) factors, such as latency, throughput, response time, and the like. In an example, the user 210 may interact with the user device 208 to specify their preferences as the user-preference data 206A giving their preferences associated with either the sustainable routing or the unsustainable routing.

Further, the computer system 202 is configured to receive request data associated with a routing operation. The request data may be received from the user device 208 associated with the user 210. In an example, the user 210 may interact with an application that may be running on the user device 208, such as an e-commerce website to generate the request data for the routing operation. For example, the user 210 may be accessing an e-commerce website. Here, the request data may be associated with, for example, a request for searching or querying a particular product, a request for retrieving product information of the particular product, a request for purchasing the particular product, and the like.

In an example, the routing operation refers to a process of directing data packets from one node, such as from a first router associated with the user device 208 to another node, such as a second router associated with a destination device. The routing operation is an autonomous process handled by network devices to direct the data packets to its intended destination. In this regard, routing rules or routing data is utilized to identify a routing path for the transmission of the data packets, for example, from the first router to the second router.

In particular, the routing operation refers to the systematic processes and methodologies employed by network devices, particularly routers, to determine an optimal path for data packets as they traverse a network from a source to a destination. The routing operation includes dynamic adjustments to routing paths based on real-time network conditions, policy-based routing decisions, and load balancing techniques to optimize network performance and resource utilization. The sustainable routing operation may include prioritizing the use of sustainable cloud resources over latency associated with the target resource. The sustainable cloud resources refer to the cloud resources that run on the sustainable energy resources such as wind energy, solar energy, hydroelectricity, and the like.

In an example, the request data includes message data for the routing operation. The request data may also include destination data associated with a destination of the routing operation. The message data includes information associated with processing of a user request. For example, when the request data is associated with a purchase on the e-commerce website, the message data may include user identification information for authentication, specific operational parameters relevant to the purchase (such as product details, service options, or transaction amounts), and any additional contextual information that is required for processing, such as preferences or special instructions. Further, the destination data includes information associated with the destination of the routing operation. In an embodiment, the destination data may include technical specifications that define where the request is directed and how the request should be handled.

Further, the computer system 202 is configured to determine routing zone data based on the request data. The routing zone data indicates at least one of one or more routing zones 204 for executing the routing operation, latency data associated with each routing zone of the one or more routing zones 204, or sustainability score data associated with each routing zone of the one or more routing zones 204.

By way of example, and not by limitation, the computer system 202 may determine the one or more routing zones 204 based on the request data. The one or more routing zones 204 are defined as distinct, geographically separated data centers that facilitate networking operations within a cloud service provider's infrastructure. The one or more routing zones 204 are designed to operate independently while remaining interconnected through high-speed, low-latency networks. In an example, based on the request data for purchasing a product from the e-commerce website, the one or more routing zones 204 associated with the purchase request may be determined. The one or more routing zones 204 may include the first routing zone 204A, the second routing zone 204B, up to the Nth routing zone 204N. Each of the first routing zone 204A, the second routing zone 204B, up to the Nth routing zone 204N may be capable of carrying out the routing operation for fulfilling the purchase.

In an example, each routing zone of the one or more routing zones 204 is associated with at least one compute resource. In an example, each of the one or more routing zones 204 may include a data center. Further, the at least one compute resource may correspond to, but is not limited to, switches, storage, routers, servers, etc. In this regard, the each of the one or more routing zones 204 may provide an independent infrastructure for the transmission of the message data from the source to the destination.

Each routing zone of the one or more routing zones 204 is associated with at least one compute resource. The at least one compute resource refers to the fundamental components of a computing environment that provide the processing power necessary to execute tasks, run applications, and perform calculations. The at least one compute resource may be a physical resource or a virtual resource used for various computing operations, such as data processing, application hosting, and running complex algorithms.

Further, the computer system 202 determines the latency data associated with each routing zone of the one or more routing zones 204 and the sustainability score data associated with each routing zone of the one or more routing zones. In an example, the computer system 202 may receive the latency data and the sustainability score data from a cloud using the application programable interfaces (APIs). The APIs may be a set of rules and protocols that allow different software applications to communicate with each other. The APIs may define the methods and data formats that applications can use to request and exchange information, enabling them to interact seamlessly.

By way of example, and not by limitation, the computer system 202 receives the latency data associated with the first routing zone 204A, the second routing zone 204B up to the Nth routing zone 204N. The latency data may include a first latency for the first routing zone 204A, a second latency for the second routing zone 204B, up to an Nth latency for the Nth routing zone 204N. The latency may be a metric used to quantify a delay experienced in a system, application, or network when processing requests or transmitting data packets. The latency measures time taken for data packets to travel from the source to the destination and back, often referred to as round-trip time (RTT). In an example, the first latency may correspond to “20 μs”, and the second latency may correspond to “50 μs”.

Similarly, the computer system 202 receives the sustainability score data corresponding to the first routing zone 204A, the second routing zone 204B up to the Nth routing zone 204N. The sustainability score data may include a first sustainability score for the first routing zone 204A, and a second sustainability score for the second routing zone 204B, up to the Nth sustainability score for the Nth routing zone 204N. The sustainability score may refer to a metric that quantifies the environmental sustainability of a specific routing zone of the one or more routing zones 204 within a cloud infrastructure. The sustainability score for a routing zone of the one or more routing zones 204 integrates various criteria, including energy consumption of the routing zone from renewable sources, routing zone efficiency, waste management practices, and adherence to environmental regulations, thereby enabling to assess the ecological impact of the routing zone when data packets are transmitted. In an example, the first sustainability score may correspond to “40%” and the second sustainability score may correspond to “70%”.

In an embodiment, the computer system 202 is configured to generate user-specific routing data 202A. The computer system 202 may generate the user-specific routing data 202A for executing the routing operation. The user-specific routing data 202A is determined based on the routing data and the user-preference data 206A.

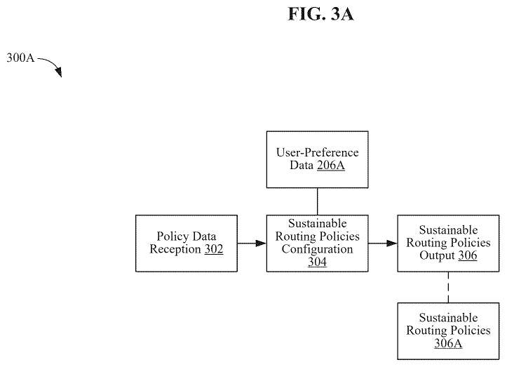

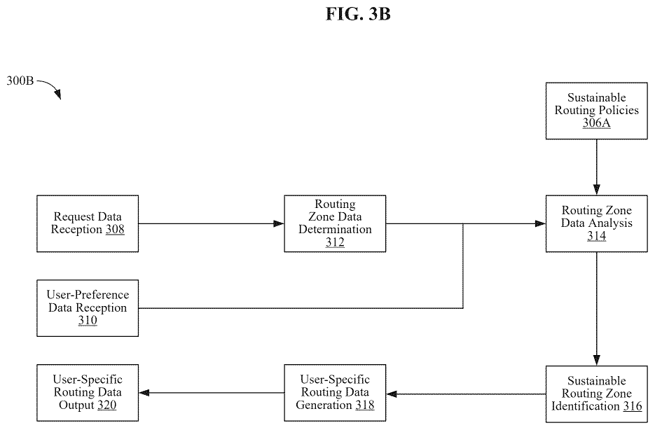

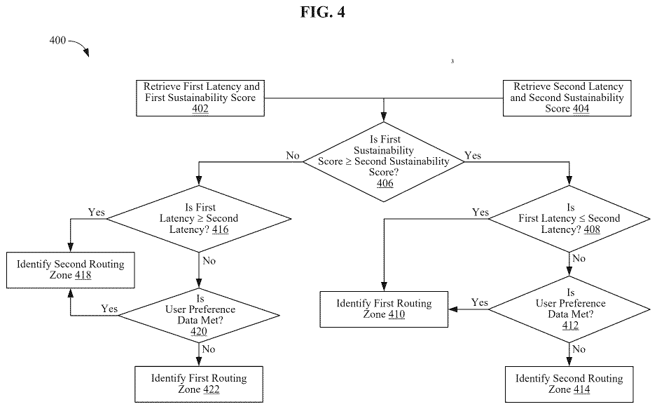

In an embodiment, the computer system 202 determines at least one routing zone of the one or more routing zones 204 based on the routing zone data and the user-preference data 206A. In an example, if the user-preference data 206A may indicate the sustainable routing condition data, the computer system 202 may select a routing zone that is sustainable from the one or more routing zones 204 for executing the routing operation. The sustainable routing zone is associated with sustainable cloud resources. For example, based on the user-preference data 206A indicating the sustainable routing condition data, the computer system 202 may determine the sustainable routing zone having a higher sustainability score while ensuring that the latency is not less than a predefined threshold. For example, the first latency may be “40%” and the second sustainability score may be “70%”. Further, based on the second sustainability score being greater than the first latency, e.g., the second routing zone 204B is more sustainable than the first routing zone 204A, the computer system 202 is configured to identify the second routing zone 204B for carrying out the routing operation. Details of the operations associated with the generation of the user-specific routing data 202A are explained in conjunction with FIG. 3 and FIG. 4.

In an embodiment, the computer system 202 is configured to output the user-specific routing data 202A. The computer system 202 may output the user-specific routing data 202A to the one or more routing zones 204. In an example, the computer system 202 may output the user-specific routing data 202A to the sustainable routing zone to be used for routing for carrying out the routing operation. Further, the computer system 202 may store the user-specific routing data 202A. In an embodiment, the computer system 202 may store the user-specific routing data 202A in the one or more data sources 206. In an alternate embodiment, the volatile memory of the computer system 202 may store the user-specific routing data 202A.

FIG. 3A is a diagram 300A that illustrates exemplary operations for generating sustainable routing policies, in accordance with an embodiment of the disclosure. FIG. 3A is explained in conjunction with elements from FIG. 1 and FIG. 2. With reference to FIG. 3A, the diagram 300A illustrates exemplary operations for generating one or more sustainable routing policies 306A. The exemplary operations illustrated in the diagram 300A start at 302 and are performed by any computing system, apparatus, or device, such as by the computer 102 of FIG. 1 or by the computer system 202 of FIG. 2.

At 302, a policy data reception operation is performed. In the policy data reception operation, the computer system 202 is configured to receive policy data. The computer system 202 receives the policy data from the one or more data sources 206. The policy data is associated with a plurality of routing policies. The plurality of routing policies is a set of rules and configurations that determine how data packets are directed through a network. The plurality of routing policies governs the selection of paths that data takes from its source to its destination, influencing factors such as performance, reliability, and security.

By way of example, and not by limitation, each of the plurality of routing policies corresponds to at least one of round robin, least connections, least response time, internet protocol (IP) hash, weighted round robin, and the like. Further, the plurality of routing policies is associated with the one or more routing zones 204.

At 304, a sustainable routing policies configuration operation is performed. In the sustainable routing policies configuration operation, the computer system 202 is configured to configure one or more sustainable routing policies 306A. The one or more sustainable routing policies 306A are configured based on the policy data and the user-preference data 206A.

In an embodiment, the computer system 202 may filter the one or more sustainable routing policies 306A that are associated with the sustainable routing from the plurality of routing policies. In particular, the sustainable routing includes utilization of sustainable resources, such as energy consumption from renewable power sources, net-zero carbon emission, or power usage effectiveness. Further, the computer system 202 may configure the one or more sustainable routing policies 306A based on the user-preference data 206A. For example, a sustainable routing policy of the one or more sustainable routing policies 306A are configured to route the request data for the routing operation only to a sustainable routing zone of the one or more routing zones 204 even when the sustainable routing zone may be associated with greater latency when the user-preference data indicates sustainable routing condition data or that the user 210 wants to perform the routing operation via sustainable routing zones.

At 306, a sustainable routing policies output operation is performed. In the sustainable routing policies output operation, the computer system 202 is configured to output the one or more sustainable routing policies 306A. Further, the computer system 202 may store the one or more sustainable routing policies 306A in the one or more data sources 206. In an alternate embodiment, the computer system 202 may store the one or more sustainable routing policies 306A in the storage 122B.

FIG. 3B is a diagram 300B that illustrates exemplary operations for generating user-specific routing data 202A, in accordance with an embodiment of the disclosure. FIG. 3B is explained in conjunction with elements from FIG. 1, FIG. 2, and FIG. 3A. With reference to FIG. 3B, the operations may start at 308.

At 308, a request data reception operation is performed. In the request data reception operation, the computer system 202 is configured to receive request data. The request data may be received from the user device 208 associated with the user 210. In an embodiment, the computer system 202 may receive the request data associated with the routing operation for the transmission or routing of data packets to a destination. The routing operation refers to a process and methodology employed by network devices, particularly routers, to determine an optimal path for the routing of the data packets as they traverse a network from a source, such as a source network device, to a destination, such as a destination network device.

By way of example, but not by limitation, the user 210 may access an application on the user device 208. Further, the user 210 may access the application for an ongoing session (such as the interaction session). During this interaction session, the user 210 may generate the request data for purchasing a product from the e-commerce website. Subsequently, the request data may correspond to the transmission of data packets for placing an order with a server of the application. The request data may include message data for the routing operation and destination data associated with the destination of the routing operation. The message data may indicate information to be transmitted to the server of the application for the purchase. For example, the message data may include product description to be purchased, address for delivery or billing, identification information of the user 210, and the like. Further, the destination data may indicate information, or an address associated with the destination of the data packets. In an example, the destination data may indicate an address, such as an internet protocol (IP) address for the server of the application.

At 310, a user-preference data reception operation is performed. In the user-preference data reception operation, the computer system 202 is configured to receive the user-preference data 206A associated with the user 210. The user-preference data 206A indicates at least one of the sustainable routing condition data, or the unsustainable routing condition data. The sustainable routing condition data includes conditions for following sustainable routing protocols, whereas the unsustainable routing condition data includes conditions for not following sustainable routing.

The sustainable routing refers to a network routing methodology that optimizes the path selection for data transmission based on, for example, carbon emission, environmental impact, and energy consumption, in addition to traditional performance metrics such as latency and bandwidth. Similarly, the unsustainable routing condition data includes conditions that define the unsustainable routing. The unsustainable routing refers to the network routing methodology that prefers non-functional requirements factors such as latency, throughput, response time, and the like.

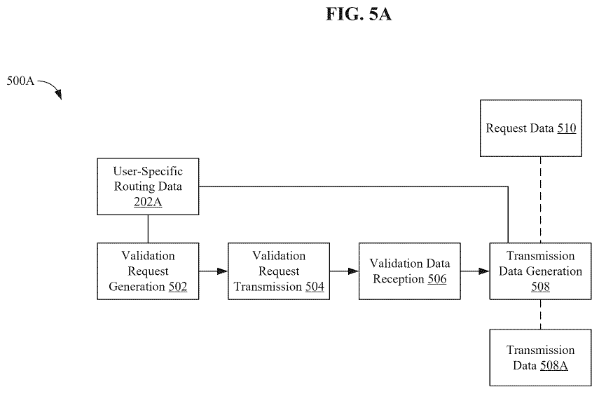

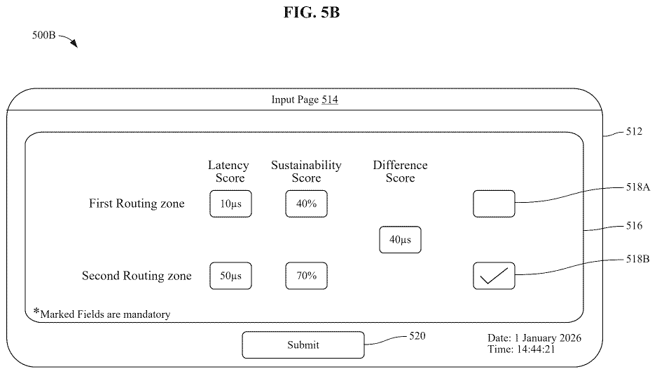

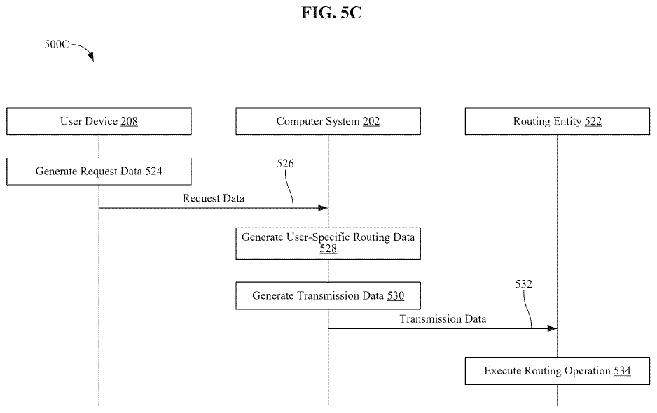

In an embodiment, the user-preference data 206A may indicate that the user 210 has approved the sustainable routing policies indicating the sustainable routing condition data. In an alternate embodiment, the user-preference data 206A may indicate that the user 210 has selected the unsustainable routing policies indicating the unsustainable routing condition data. In an example, the computer system 202 generates a validation request to receive the user-preference data 206A from the user 210 via the user device 208. The computer system 202 may transmit the validation request to the user 210 asking for their preference associated with routing operation. The validation request is explained in conjunction with FIG. 5A, FIG. 5B, FIG. 5C.

In an embodiment, the computer system 202 may receive the user-preference data 206A for an interactive session between the user 210 and the user device 208. In an example, the interactive session may be associated with an application for example, but is not limited to, an e-commerce application, a productivity application, a social media application, an entertainment application, and so forth. In an example, the interactive session may be for a request associated with one of a platform as a service (PAAS), an infrastructure as a service (IAAS), a container as a service (CASS), a serverless compute, and the like.

In an example, the user-preference data 206A may indicate sustainable routing condition data, such as conditions indicating that the user 210 agrees to sustainable routing whenever possible. In this regard, whenever a sustainable routing zone is available, the routing operation initiated by the user 210 should be performed using the sustainable routing zone. In an alternate example, the user-preference data 206A may indicate unsustainable routing condition data, such as conditions indicating that the user 210 has opted for unsustainable routing for reduced latency, reliability, and/or throughput. In this regard, a routing zone having the least NFR value will be selected for performing the routing operation, irrespective of its sustainability score. In an alternate embodiment, the user-preference data 206A may indicate that the user 210 agrees for sustainable routing given a latency, a throughout, and/or a reliability of a sustainable routing zone is not less than a threshold. In this regard, whenever a sustainable routing zone is available that meets with the specific requirements of the user 210 that sustainable routing zone is selected for performing the routing operation.

At 312, a routing zone data determination operation is performed. In the routing zone data determination operation, the computer system 202 may be configured to determine routing zone data based on the request data. The routing zone data indicates the one or more routing zones 204 for executing the routing operation. The one or more routing zones 204 may correspond to individual data centers that may be used for performing the routing operation. In other words, each of the one or more routing zones 204 may have a standalone networking infrastructure for the routing of the data packets or the message data to the destination. In an example, the one or more routing zones 204 may be data centers positioned across different geographical locations across the world. Further, each of the one or more routing zones 204 may have different capacities, energy consumption, energy emission, security infrastructure, cooling infrastructure, and maintenance needs. For example, each of the one or more routing zones 204 may be communicatively connected, either directly or indirectly, with the user device 208 and the server of the application for performing the routing operation or the transmission of the message data from the user device 208 to the server.

Pursuant to the present example, the one or more routing zones 204 may include the first routing zone 204A, the second routing zone 204B, up to the Nth routing zone 204N. For example, based on the source, e.g., the user device 208, and the destination, e.g., the server of the application, the one or more routing zones 204 are identified. Thereafter, the routing zone data is determined for the one or more routing zones 204. The routing zone data may include a selection of at least one routing zone of the one or more routing zones 204 for performing the routing operation, latency data associated with each routing zone of the one or more routing zones 204, and/or the sustainability score data associated with each routing zone of the one or more routing zones 204.

While the embodiments of the present disclosure described that there are multiple routing zones capable of transmitting data between the source or the user device 208 and the destination, however, this should not be considered as a limitation. In certain cases, there may be only one routing zone capable for the transmission of the message data to the destination, or there may be only two routing zones capable for the transmission of the message data to the destination. In the case of one routing zone, the routing operation may be performed using the single routing zone irrespective of the sustainable or unsustainable nature of the routing zone. In the case of two routing zones, the routing operation may be performed using one of the two routing zones based on user preference and the sustainable or unsustainable nature of each of the two routing zones.

Further, the computer system 202 receives the latency data associated with each routing zone of the one or more routing zones 204. In an example, the computer system 202 may configure one or more sustainability checks to receive latency data. The sustainability checks refer to systematic evaluations conducted to assess the operational status and performance of a system, application, or service. The sustainability checks are designed to monitor various components, ensuring they are functioning correctly and efficiently. Further, the sustainability checks are utilized to receive the latency associated with each routing zone of the one or more routing zones 204. In an example, the latency data may include the first latency of “40 μs” corresponding to the first routing zone.

In an example, the computer system 202 receives the sustainability score data associated with each routing zone of the one or more routing zones 204. In an example, the computer system 202 may receive the sustainability score data from the cloud using the application programable interfaces (API) associated with the cloud. In an example, the sustainability score data may include the first sustainability score of “40%” for the first routing zone 204A, and the second sustainability score of “70%” for the second routing zone 204B. The sustainability score of each of the one or more routing zones 204 may indicate how much energy consumed by the routing zone is coming from renewable resources and how much emissions are generated by the routing zone while performing a routing operation. For example, such sustainability score for the routing zone may be pre-determined based on power consumption, sources of power, device conditions, etc. associated with the routing zone.

Moreover, the computer system 202 determines the latency data associated with each routing zone of the one or more routing zones 204. In an example, the computer system 202 may determine the latency data indicating the time taken for transmission or travel of the data packets of the message data from the source or the user device 208 to the destination, such as the server of the application. The latency data may indicate a latency, for example, in milliseconds (ms) or microseconds (μs), for the travel of the data packets of the message data from the source or the user device 208 to the destination. In an example, the latency data may include the first latency of “50 μs” for the first routing zone 204A, and the latency of “40 μs” for the second routing zone 204B. In an embodiment, the routing zone data may also include a difference score. The difference score corresponds to a difference value between a latency of the first routing zone 204A and a latency of the second routing zone 204B. For example, the latency difference may be determined for each pair of routing zones from the one or more routing zones 204. The latency difference may indicate a routing zone having the least or lowest latency and/or a routing zone having the highest latency.

In an embodiment, the routing zone data may also include capacity data for each routing zone of the one or more routing zones 204. The capacity of a routing zone may be measured based on, for example, space, power, cooling, computing resources, and network connectivity.

In an embodiment, the routing zone data may also include a compliance status associated with each of the one or more routing zones 204 for performing the routing operation based on one or more compliance rules. The compliance rules refer to a set of predefined guidelines and criteria that govern the management and direction of data traffic within a network to ensure adherence to legal, regulatory, and organizational standards. By implementing compliance rules in the routing operation, the computer system 202 can ensure that the data packets are transmitted through approved pathways or based on compliant rules. Further, the computer system 202 may restrict access to sensitive information based on jurisdictional requirements. In an example, the compliance rules may indicate that the routing operation is to be performed using a routing zone that is within a same country as the source and/or the destination. In this regard, based on the compliance rules, a first compliance status of “yes” and a second compliance of “no” corresponding to the first routing zone 204A and the second routing zone 204B, respectively, may be determined. The first compliance status may indicate that the first routing zone 204A is compliant with the compliance rule and lies within the same country as that of the source and/or the destination. On the other hand, the second compliance status may indicate that the second routing zone 204B is not compliant with the compliance rule and may lie outside of the country of the source and/or the destination. The routing zone data can be represented in Table 1 as provided below.

TABLE 1
Request data

| | | | | First | | Second | | Third | |
|---|---|---|---|---|---|---|---|---|---|
| | | | | Routing | | Routing | | Routing | |
| | | Sustain- | | Zone | | Zone | | Zone | |
| Routing | | ability | Compliance | Differ- | | Differ- | | Differ- | |
| Zones | Latency | Score | Status | ence | | ence | | ence | |
| First | 50 μs | 40% | Yes | 0 | μs | 10 | μs | 55 | μs |
| Routing | | | | | | | | | |
| Zone | | | | | | | | | |
| Second | 40 μs | 70% | No | 10 | μs | 0 | μs | 45 | μs |
| Routing | | | | | | | | | |
| Zone | | | | | | | | | |
| Third | 95 μs | 50% | Yes | 55 | μs | 45 | μs | 0 | μs |
| Routing | | | | | | | | | |

Zone

The determination of routing zone data based on the request data is a process that involves analyzing multiple variables such as, the routing zones, the latency, and the sustainability scores. As the computer system 202 analyzes the above-mentioned variables dynamically and in real-time, it will be cumbersome for a human to perform this analysis mentally. The computational capabilities of the computer system 202 are vital in evaluating and optimizing routing decisions, ensuring efficiency and accuracy.

At 314, a routing zone data analysis operation is performed. In the routing zone data analysis operation, the computer system 202 may be configured to analyze the routing zone data based on the workload threshold data. Specifically, the computer system 202 compares the routing zone data of each routing zone of the one or more routing zones 204 with the workload threshold data.

Further, the computer system 202 is configured to retrieve one or more sustainable routing policies 306A. The one or more sustainable routing policies 306A may be configured based on the based on the policy data and the user-preference data 206A. In an embodiment, the one or more sustainable routing policies 306A are retrieved from the one or more data sources 206. In an alternate embodiment, the one or more sustainable routing policies 306A are retrieved from the storage 122B of the computer system 202. The one or more sustainable routing policies 306A may be filtered from the plurality of routing policies, such that the one or more sustainable routing policies 306A are associated with the sustainable routing. To this end, the routing zone data analysis includes analyzing the one or more sustainable routing policies 306A to identify whether at least one routing zone of the one or more routing zones 204 for executing the routing operation is serviceable by at least one sustainable routing policy of the one or more sustainable routing policies 306A.

By way of example, but not limitation, the one or more sustainable routing policies 306A may correspond to round robin, least connections, least response time, internet protocol (IP) hash, weighted round robin, and the like. Further, the one or more sustainable routing policies 306A may be associated with the sustainable routing condition data. The operations associated with the configuration of the one or more sustainable routing policies 306A are explained in FIG. 3A.

In an embodiment, the sustainable routing condition data indicates a workload threshold data for a specific sustainable routing policy of the one or more sustainable routing policies 306A. The workload threshold data may include a workload threshold. In an example, the workload threshold may correspond to a latency that the user 210 may agree upon or an amount of latency that is acceptable to the user 210 when the routing operation is performed via a sustainable routing zone of the one or more routing zones 204. In an example, the workload threshold is “45 μs”. Further, the computer system 202 may select the specific sustainable routing policy of the one or more sustainable routing policies 306A or a specific routing zone of the one or more routing zones 204 based on the working threshold.

In an alternate embodiment, the workload threshold may also correspond to the difference score that the user 210 may agree upon. Based on the difference score for latency of each pair of routing zones of the one or more routing zones 204, the computer system 202 may select the specific sustainable routing policy of the one or more sustainable routing policies 306A.

In an embodiment, the computer system 202 is configured to compare at least one of the latency data associated with each routing zone of the one or more routing zones 204 or the sustainability score data associated with each routing zone of the one or more routing zones with the workload threshold data. In an example, the workload threshold is defined by the user 210 based on latency. In such a case, the computer system 202 compares the latency associated with each routing zone of the one or more routing zones 204 with the workload threshold to identify whether the workload threshold is satisfied by the latency of the one or more routing zones 204. In an alternate example, the workload threshold is defined by the user 210 based on the sustainability score. In such a case, the computer system 202 compares the sustainability score associated with each routing zone of the one or more routing zones 204 with the workload threshold to identify whether the workload threshold is satisfied by the sustainability score of the one or more routing zones 204.

In an embodiment, the computer system 202 is configured to determine at least one of the latency data or the sustainability score data associated with the sustainable routing zone meets the workload threshold data based on the comparison. Specifically, the computer system 202 determines that the second sustainability score of the second routing zone 204B is greater than the first sustainability score of the first routing zone 204A, indicating that the second routing zone 204B is more sustainable based on the analysis. Further, the computer system 202 determines that the second latency of the second routing zone 204B is less than the first latency of the first routing zone 204A based on the analysis. In addition, the computer system 202 may determine that the workload threshold indicating latency to be less than 10 ms is satisfied by both the first routing zone 204A and the second routing zone 204B. Alternatively, the computer system 202 may determine that the workload threshold indicating sustainability score to be more than 45% is satisfied by the second routing zone 204B.

By way of example, but not limitation, the computer system 202 firstly determines the second sustainability score (70%) of the second routing zone is greater than the first sustainability score (40%) of the first routing zone based on the analysis. Further, the computer system 202 determines the second latency (40 μs) of the second routing zone is less than the first latency (40 μs) of the first routing zone (50 μs). The computer system 202 further determines the first latency is also less than the workload threshold (45 μs).

In an alternate embodiment, the computer system 202 may utilize the difference score associated with each pair of routing zones of the one or more routing zones 204 for the analysis of the routing zone data. The computer system 202 identifies the difference score between the latency data of the first routing zone and the latency data of the second routing zone and compares the difference score with the workload threshold. Upon determination that the sustainability data (the second sustainability score) of the second routing zone is greater than the sustainability data (the first sustainability score) of the first routing zone and the difference score is less than the workload threshold, the computer system 202 identifies the second routing zone as the sustainable routing zone.

By way of example, but not limitation, the computer system 202 first determines the second sustainability score (70%) of the second routing zone 204B is greater than the first sustainability score (40%) of the first routing zone 204A based on the analysis. The computer system 202 further determines the difference score (10 μs) between the first routing zone 204A and the second routing zone 204B is also less than the workload threshold (40 μs).

At 316, a sustainable routing zone identification operation is performed. In the sustainable routing zone identification operation, the computer system 202 may be configured to identify a sustainable routing zone of the one or more routing zones 204 based on the analysis. As discussed above, the computer system 202 identifies the second routing zone 204B as the sustainable routing zone based on the determination that the second sustainability score of the second routing zone 204B is greater than the first sustainability score of the first routing zone 204A. In addition, the latency of the first routing zone 204A is greater than the latency of the second routing zone 204B, and the latency of the second routing zone 204B is greater than the workload threshold data. Based on this analysis, the second routing zone 204B is identified as the sustainable routing zone. Further, the sustainable routing zone is used for the routing operation. The sustainable routing zone or the second routing zone 204B is associated with the specific sustainable routing policy.

At 318, a user-specific routing data generation operation is performed. In the user-specific routing data generation operation, the computer system 202 may be configured to generate the user-specific routing data 202A. The user-specific routing data 202A is generated based on the identified sustainable routing zone and the specific sustainable routing policies associated therewith. The user-specific routing data 202A may include the latency data, the sustainability score data, and the difference score associated with the sustainable routing zone. The user-specific routing data may indicate that the data packets of the message data are to be transmitted via the sustainable routing zone or the second routing zone 204B. Accordingly, the user-specific routing data defines a routing path for the transmission of the data packets of the message data.

At 320, a user-specific routing data output operation is performed. In the user-specific routing data output operation, the computer system 202 may be configured to output the user-specific routing data 202A. The computer system 202 may output the user-specific routing data 202A to, for example, the user device 208, a network device or a router associated with the user device 208, and/or the one or more routing zones 204. In an example, the computer system 202 may output the user-specific routing data 202A to the identified sustainable routing zone or the second routing zone 204B to carry out the routing operation. In an alternate example, the computer system 202 may output the user-specific routing data 202A to the network device associated with the user device 208 for defining path, routing policy, and the like for the data packets to be transmitted. Further, the computer system 202 may store the user-specific routing data 202A. In an embodiment, the computer system 202 may store the user-specific routing data 202A in the one or more data sources. In an alternate embodiment, the volatile memory of the computer system 202 may store the user-specific routing data 202A.

In an embodiment, the computer system 202 is configured to control an execution of the routing operation based on the determination that the at least one of the latency data or the sustainability score data associated with the sustainable routing zone meets the workload threshold data. Specifically, the computer system 202 identifies the sustainable routing zone for performing the routing operations.

FIG. 4 is a diagram that illustrates an exemplary flowchart 400 of a method for identifying a routing zone, in accordance with an embodiment of the disclosure. FIG. 4 is explained in conjunction with elements from FIG. 1, FIG. 2, FIG. 3A and FIG. 3B. With reference to FIG. 4, operations may start at 402.

At 402, a first latency and a first sustainability score are retrieved. In an embodiment, the computer system 202 is configured to retrieve the first latency and the first sustainability score. The first latency and the first sustainability score are associated with the first routing zone 204A of the one or more routing zones 204. The computer system 202 may receive the first latency and the first sustainability score from the one or more data sources 206. In an example, the computer system 202 may receive the first latency of “40 μs”, and the first sustainability score of “70%”.

At 404, a second latency and a second sustainability score are retrieved. In an embodiment, the computer system 202 is configured to retrieve the second latency and the second sustainability score. The second latency and the second sustainability score are associated with the second routing zone 204B of the one or more routing zones 204. The computer system 202 may receive the second latency and the second sustainability score from the one or more data sources 206. In an example, the computer system 202 may receive the second latency of “50 μs”, and the second sustainability score of “50%”.

At 406, a determination is made to determine whether the first sustainability score is greater than or equal to the second sustainability score. In an embodiment, the computer system 202 is configured to compare the first sustainability score of the first routing zone 204A with the second sustainability score of the second routing zone 204B. In an embodiment, the computer system 202 determines whether the first sustainability score is greater than or equal to the second sustainability score or not based on the comparison.

By way of example, and not by limitation, the computer system 202 determines that the first sustainability score of “70%” is greater than the second sustainability score of “50%” based on the comparison. The first routing zone 204A having the higher first sustainability score compared with the second sustainability score of the second routing zone 204B indicates that the first routing zone 204A has greater number of cloud resources running on the sustainable energy sources.

Further, based on the determination that the first sustainability score is greater than the second sustainability score, the operations of the flowchart 400 may move to 408. On the contrary, based on the determination that the second sustainability score is greater than the first sustainability score, the operations of the flowchart 400 may move to 416.

At 408, a determination is made to determine whether the first latency is less than or equal to the second latency. In an embodiment, the computer system 202 is configured to compare the first latency of the first routing zone 204A with the second latency of the second routing zone 204B. In an embodiment, the computer system 202 determines whether the first latency is less than or equal to the second latency based on the comparison.

By way of example, but not limitation, the computer system 202 based on the comparison determines that the first latency of “40 μs” is less than or equal to the second sustainability score of “50 μs”. The first routing zone 204A having the first latency less than the second latency of the second routing zone 204B indicates that the user data transmitted to the first routing zone 204A allows for a faster transmission or less travel time of the user data.

Further, based on the determination that the first latency is less than or equal to the second latency, the computer system 202 may be configured to pass the flow of operations to 410.

At 410, the first routing zone is identified. In an embodiment, the computer system 202 is configured to identify the first routing zone for performing the routing operation based on the determination, at 406, that the first sustainability score of the first routing zone 204A is greater than or equal to the second sustainability score of the second routing zone 204B, as well as the determination, at 408, that the first latency of the first routing zone 204A is less than or equal to the second latency of the second routing zone 204B. The first routing zone 204A is identified for executing the routing operation associated with the request data. In an example, the computer system 202 determines that the first routing zone 204A having the first latency “40 μs”, and the first sustainability score “70%” is a sustainable routing zone for executing the routing operation.

Alternatively, at 408, if the computer system 202 determines that the first latency is greater than the second latency, the operations of the flowchart 400 may move to 412.

At 412, a determination is made to determine that the user-preference data is met. In an embodiment, the computer system 202 is configured to determine that the user-preference data is met for the first routing zone 204A based on the first sustainability score and the first latency of the first routing zone 204A. For example, the first sustainability score being greater than or equal to the second sustainability score of the second routing zone 204B indicates that the first routing zone 204A is more sustainable. However, the first latency is greater than the second latency. Herein, if the user-preference data 206A indicative of user-preferred maximum latency and/or preference of the user for routing through sustainable routing zone or unsustainable routing zone is not met by the first latency of the first routing zone 204A, then user experience may be affected. The user-preference data 206A indicates the selection of the sustainable routing or the unsustainable routing by the user 210.

Further, based on the determination that the user-preference data 206A indicates sustainable routing and the user-preferred latency is higher than or equal to the first latency, the operations of the flowchart 400 may move to 410. In other words, the computer system 202 may determine that the first sustainability score and/or the first latency of the first routing zone 204A meets the user-preference data 206A. In such a case, the first routing zone 204A is identified for performing the routing operation of the request data. Subsequently, the operation may go back to 410.

In an embodiment, the computer system 202 is configured to identify a specific routing zone from the first routing zone and the second routing zone for the routing operation. The specific routing zone is identified based on the comparison and the user-preference data 206A. In case the user-preference data 206A includes sustainable routing condition data indicating the sustainable routing, the computer system 202 identifies the first routing zone for the routing operation.

By way of example, but not limitation, the computer system 202 may receive the first latency of “30 μs” and the first sustainability score of “70%”. Similarly, the computer system 202 receives the second latency of “10 μs” and the second sustainability score of “50%”. Firstly, the computer system 202 compares the first sustainability score with the second sustainability score to determine that the first sustainability score of “70%” is greater than the second sustainability score of “50%”. Upon determination that the first sustainability score is less than the second sustainability score, the computer system 202, compares the first latency with the second latency to determine that the first latency of “30 μs” is greater than second latency of “10 μs”. The above determination indicates that the first routing zone 204A has the greater sustainability score but also has the greater latency. Further, the computer system 202 utilizes the user-preference data 206A to determine the specific routing zone for the routing operation. For example, if the user-preference data 206A indicates sustainable routing condition data indicating to choose sustainable routing when the latency is less than 10 ms, the computer system 202 identifies the first routing zone 204A as the sustainable routing zone.

However, if the computer system 202 determines that the first sustainability score and/or the first latency of the first routing zone 204A does not meet the user-preference data 206A then the operation of the flowchart 400 may move to 414.

At 414, the second routing zone is identified. In an embodiment, the computer system 202 identifies the second routing zone 204B for the routing operation based on the user-preference data 206A. The computer system 202 identifies the second routing zone 204B for the routing operation based on the determination that the first sustainability score of the first routing zone 204A is greater than the second sustainability score of the second routing zone 204B, the second latency of the second routing zone 204B is less than the first latency of the first routing zone 204A, and the user-preference data 206A corresponds to unsustainable routing condition data whereby lower latency is preferred over higher sustainability.

By way of example, but not limitation, in case the user-preference data 206A includes the unsustainable routing condition data indicating unsustainable routing conditions for reduced latency, the computer system 202 identifies the second routing zone 204B having the latency of “10 μs” the sustainability score “50%” indicating low usage of sustainable resources and less latency for the routing operation.

Referring back to 406, based on the determination that the first sustainability score is less than the second sustainability score, the computer system 202 passes the flow of operation to 416. In particular, the first routing zone 204A is identified to be less sustainable than the second routing zone 204B.

At 416, a determination is made to determine that the first latency is greater than or equal to the second latency. In an embodiment, the computer system 202 is configured to determine whether the first latency is greater than or equal to the second latency based on the determination that the first sustainability score is less than the second sustainability score. In an embodiment, if the first sustainability score is less than the second sustainability score, the computer system 202 compares the first latency with the second latency. Further, based on the comparison, the computer system 202 determines that the first latency is greater than the second latency. In an alternate embodiment, the computer system 202 determines that the first latency is less than the second latency based on the comparison.

Further, based on the determination that the first latency is greater than or equal to the second latency, the operations of the flowchart 400 may move to 418. If the computer system 202 determines that the first latency is less than the second latency, the operations of the flowchart 400 may move to 420.

At 418, the second routing zone is identified. In an embodiment, the computer system 202 is configured to identify the second routing zone 204B based on the determination that the first sustainability score of the first routing zone 204A is less than the second sustainability score of the second routing zone 204B and the first latency of the first routing zone 204A is greater than the second latency of the second routing zone 204B. In an example, the computer system 202 identifies the second routing zone 204B having the second latency and the second sustainability score for executing or performing the routing operation.

At 420, a determination is made to determine that the user-preference data is met. In an embodiment, the computer system 202 is configured to determine user preferences or conditions specified by the user 210 with regard to the routing operation based on the user-preference data 206A. For example, the user-preference data 206A may indicate choosing sustainable routing when the latency of the sustainable routing zone is less. In such a case, a determination is made to check whether the second latency of the second routing zone 204B is less than a latency threshold defined by the user 210. For example, if the second latency is less than the latency threshold, then the second routing zone 204B may be selected for performing the routing operation. However, if the second latency is greater than the latency threshold, then the first routing zone 204A may be selected for performing the routing operation. In this regard, the first routing zone 204A may not be using renewable resources and thus may not be a green routing zone, but the first routing zone 204A may have less latency thereby improving user experience.

Further, based on the determination that the user-preference data 206A indicates sustainable routing and the second latency is less than the user-defined latency threshold, the operations of the flowchart 400 may move to 418. Subsequently, the second routing zone 204B having the higher sustainability score even with higher latency is selected for performing the routing operation.

However, if the computer system 202 determines that the user-preference data 206A indicates unsustainable routing and the second latency is greater than the user-defined latency threshold, the operations of the flowchart 400 may move to 422.

At 422, the first routing zone is identified. In an embodiment, the computer system 202 identifies the first routing zone for the routing operation based on the user-preference data 206A. The computer system 202 identifies the first routing zone 204A for the routing operation based on the determination that while the first sustainability score of the first routing zone 204A is less than the second sustainability score of the second routing zone 204B, the first latency of the first routing zone 204A is less than the second latency of the second routing zone 204B. Further, since the user-preference data 206A includes unsustainable routing condition data, such as choosing to route through unsustainable routing zones to meet desired NFR, therefore, the first routing zone 204A is identified for performing the routing operation.

In this manner, the user 210 can select a manner in which the routing operation is to be performed. In particular, the user 210 will have the control to select sustainable routing or unsustainable routing depending on their needs or requirements. The control of the user 210 to be able to actively contribute to reduced energy consumption and/or emission based on a selection of the sustainable routing zones may promote energy savings and reduced emissions. Further, the user 210 may provide different preferences, for example, the unsustainable routing zones for routing time-sensitive data packets, such as voice call data packets, video call data packets, transaction related data packets, and sustainable routing zones for routing of other non-time sensitive data packets, such as video streaming, emails, and the like. This may ensure that sustainable routing is performed without significantly affecting user experience.

To this end, based on the identification of the first routing zone 204A or the second routing zone 204B, the user-specific routing data 202A is generated. For example, when the first routing zone 204A is identified for performing the routing operation, the user-specific routing data 202A may indicate the first routing zone 204A as a selected specific routing zone for the routing operation. Alternatively, when the second routing zone 204B is identified for performing the routing operation, the user-specific routing data 202A may indicate the second routing zone 204B as a selected specific routing zone for the routing operation.

Although the present example describes the selection of the routing zone for performing the routing operation from two routing zones, namely the first routing zone 204A and the second routing zone 204B, however, this should not be construed as a limitation. In various embodiments, the routing zone for performing the routing operation may be selected or identified from three or more routing zones. To this end, operations similar to the operations of the flowchart 400 may be performed to identify the routing zone for the routing operation.

FIG. 5A is a diagram 500A that illustrates exemplary operations for generating transmission data, in accordance with an embodiment of the disclosure. FIG. 5A is explained in conjunction with elements from FIG. 1, FIG. 2, FIG. 3A, FIG. 3B and FIG. 4. With reference to FIG. 5A, the operations may start at 502.

At 502, a validation request generation operation is performed. In the validation request generation operation, the computer system 202 may be configured to generate a validation request. The validation request is generated for a validation of the user-specific routing data 202A. In an embodiment, the validation request includes the user-specific routing data 202A. Specifically, the validation request includes at least the latency associated with the sustainable routing zone, the sustainability score associated with the sustainable routing zone, the difference score associated with the sustainable routing zone, and the like. Further, the validation request is generated to ask for user preference on the identified sustainable routing zone from the one or more routing zones 204.

By way of example, but not limitation, the validation request may indicate the routing zone chosen or identified for performing the routing operation. In an example, the identified routing zone may correspond to the first routing zone 204A. In such a case, the validation request may indicate the first latency of “10 μs”, the first sustainability score of 40%, and the difference score of the first routing zone 204A with other routing zones of the one or more routing zones 204. In an alternate example, the identified routing zone may correspond to the second routing zone 204B. In such a case, the validation request may indicate the second latency, the second sustainability score, and the difference score of the second routing zone 204B. In certain cases, the validation request may include all of the one or more routing zones 204 or top-ranked routing zones from the one or more routing zones 204. In this regard, the identified routing zone for the routing operation may be highlighted or pre-selected for validation. A manner in which a routing zone of the one or more routing zones 204 is identified for the routing operation is described in detail in conjunction with, for example, FIG. 4. Further, the validation request is explained in detail in conjunction with, for example, FIG. 5B.

At 504, a validation request transmission operation is performed. In the validation request transmission operation, the computer system 202 may be configured to transmit the validation request to the user device 208 of the user 210. The validation request includes the user-specific routing data 202A that is transmitted to the user 210 seeking the consent of the user 210 on the identified routing zone for performing the routing operation. In an example, the user 210 may interact with the user device 208 to receive the validation request.

In an embodiment, the computer system 202 may transmit the validation request to the user 210. The user 210 may utilize the validation request for giving their consent on the identified routing zone. For example, if a routing zone identified for performing the routing operation has a higher sustainability score and higher latency, then the validation request may seek consent of the user 210 for the use of the identified routing zone that slightly affects user experience due to latency.

To this end, if the user 210 does not have any issue with the latency, the user 210 may approve the validation request. However, if the user 210 is working on a time-intensive operation requiring minimal latency, then the user 210 may not approve the validation request. In such a case, the user 210 may specify a different routing zone from the one or more routing zones 204 for the routing operation such that the different routing zone has minimal latency. In an example, the computer system 202 may automatically determine the different routing zone from the one or more routing zones 204 based on the refusal of the validation request.

In an embodiment, the computer system 202 may transmit the validation request to the user when the latency of the identified sustainable routing zone is greater than the workload threshold. For example, when the latency “50 μs” of the sustainable routing zone is greater than the workload threshold (40 μs), the computer system 202 may generate the validation request asking the user 210 about their preference on sustainable routing over the unsustainable routing.

At 506, a validation data reception operation is performed. In the validation data reception operation, the computer system 202 may be configured to receive the validation data. The validation data is received based on the transmitted validation request. The validation data may indicate whether the user 210 agrees or confirms the identified routing zone to be used for the routing operation or not. In an example, the validation data may indicate the user 210 selection of the sustainable routing zone for performing the routing operation.

At 508, a transmission data generation operation is performed. In the transmission data generation operation, the computer system 202 may be configured to generate transmission data 508A based on the validation data. The transmission data 508A includes request data 510 and the user-specific routing data 202A. In an embodiment, the transmission data 508A is generated based on the validation data indicating that the user 210 agrees for the routing operation to be performed based on the identified routing zone of the one or more routing zones 204. In an example, the identified routing zone may be a sustainable routing zone operating based on one or more sustainable policies. The transmission data 508A is generated for transmitting the request data to the destination via the identified sustainable routing zone of the one or more routing zones 204.

In an example, the computer system 202 receives the request data 510 associated with the user request from the one or more data sources 206. The user request is associated with the routing operation. The routing operation refers to the systematic processes and methodologies employed by network devices, particularly routers, to determine an optimal path for data packets as they traverse a network from a source to a destination. For example, the user 210 may generate the request data for purchasing a product from the e-commerce website or for transmission of a message.

By way of example, and not by limitation, if the validation data indicates the sustainable routing zone, the computer system 202 may generate the transmission data 508A based on the user-specific routing data 202A indicating the sustainable routing zone and the request data received from the user 210.

FIG. 5B is a diagram 500B that illustrates an exemplary first user interface for validation of the user-specific routing data 202A, in accordance with an embodiment of the disclosure. FIG. 5B is explained in conjunction with elements from FIG. 1, FIG. 2, FIG. 3A, FIG. 3B, FIG. 4 and FIG. 5A.

As shown in FIG. 5B, an input page 514 is rendered on a user device 512. The user device 512 may be an example embodiment of the user device 208. The input page 514 displays the validation request on the user device 512. In an example, the input page 514 corresponds to a web page or online form that is designed to collect information from the user 210 (such as customer associated with the application or a website).

The input page 514 includes a user interface (UI) element 516. The UI element 516 corresponds to a display unit. By way of example, and not by limitation, the computer system 202 is configured to display validation request in form of text data, visual representation, or a combination thereof on the display unit. The validation request may correspond to the one or more routing zones 204 for performing the routing operation. In an example, the one or more routing zones 204 for performing the routing operation includes the first routing zone 204A and the second routing zone 204B. Subsequently, the UI element 516 includes text data indicating the potential routing zones, e.g., the first routing zone 204A and the second routing zone 204B, for performing the routing operation. In addition, the UI element 516 includes text data that may correspond to the sustainability score data and the latency data associated with the one or more routing zones 204. In particular, the UI element 516 includes text data that may correspond to the first sustainability score “40%” and first latency “10 μs” associated with the first routing zone 204A. In addition, the UI element 516 includes text data that may correspond to the second sustainability score “70%” and the second latency “50 μs” associated with the second routing zone 204B. In addition, the UI element 516 includes text data that may correspond to a difference score of “40 μs” in the latency between the first routing zone 204A and the second routing zone 204B.

The UI element 516 further includes a first input box 518A and a second input box 518B. In an example, the first input box 518A and the second input box 518B corresponds to a check box for receiving a user selection. In an example, the validation request may be displayed within the input page 514 such that one of the first input box 518A or a second input box 518B is pre-selected or checked. For example, if the first input box 518A is pre-selected or checked, it would indicate that the computer system 202 has identified the first routing zone 204A for performing the routing operation based on the user-preference data 206A, routing zone data, and request data. On the other hand, if the second input box 518B is pre-selected or checked, it would indicate that the computer system 202 has identified the second routing zone 204B for performing the routing operation. Based on the sustainability score data, the latency data, and the user-specific routing data 202A indicated via the pre-selected input box, the user 210 may decide whether they want to proceed with the already identified routing zone or whether they want to choose the alternate routing zone.

In an example, the second input box 518B may be pre-selected indicating sustainable routing but higher latency. In this regard, if the user 210 wants to opt for the unsustainable routing zone to reduce the latency, then the user 210 may unselect the second input box 518B, select the first input box 518A, and click on a “submit” UI element 520. In this manner, the user 210 provides the validation data for the validation request.

Details associated with the generation of the user-preference based user-specific routing data are provided, for example, in FIG. 4. A manner in which the validation data is used is described in conjunction with, for example, FIG. 5A and FIG. 5C.

FIG. 5C is a diagram that illustrates a sequence diagram 500C for transmitting the transmission data 508A to a destination based on the user-specific routing data 202A, in accordance with an embodiment of the disclosure. FIG. 5C is explained in conjunction with elements from FIG. 1, FIG. 2, FIG. 3A, FIG. 3B, FIG. 4, FIG. 5A, and FIG. 5B. The sequence diagram 500C may include the user device 208, the computer system 202, and a routing entity 522. The sequence diagram 500C may depict operations performed by at least one of the user device 208, the computer system 202, and the routing entity 522.

The routing entity 522 refers to a component or system within a network that is responsible for determining a routing path that data packets take as they travel from a source to a destination. The routing entity 522 makes decisions about how to forward data packets based on various criteria, such as network topology, routing protocols, and policies. In an example, the routing entity 522 may be a load balancer, a router, and the like.

At 524, request data is generated. In an example, the user 210 generates the request data 510 using the user device 208. The request data is associated with a user request for a routing operation. The request data may indicate message data, such as data to be routed, and destination data, such as the address associated with a destination of the routing operation.

At 526, the request data is transmitted. In an example, the request data 510 is transmitted from the user device 208 to the computer system 202.

At 528, user-specific routing data is generated. In an example, the computer system 202 is configured to generate the user-specific routing data 202A based on the request data 510 as well as user-preference data 206A and routing zone data. In particular, the user-preference data 206A may indicate preference of the user 210 for performing the routing operation over a wired or a wireless network. According to embodiments of the present disclosure, the user 210 may specify preferences with respect to sustainable routing or unsustainable routing for various routing operations to be performed via the user device 208. To this end, the user-preference data 206A may include sustainable routing condition data indicating conditions (for example, always, whenever available, or when sustainable routing is available at desired latency) for opting sustainable routing. Moreover, the user-preference data 206A may include unsustainable routing condition data indicating conditions (for example, always, whenever available, or when unsustainable routing is available at desired latency) for opting unsustainable routing.

Further, the routing zone data may indicate sustainability score data and latency data associated with each potential routing zone of the one or more routing zones 204. The one or more routing zones may be identified based on the request data, for example, based on the source and the destination. For example, each of the one or more routing zones may be capable of fulfilling the request data for the transmission of message data to the destination. However, each of the one or more routing zones may have corresponding latency and sustainability score. Moreover, each of the one or more routing zones may be located in different geographical regions. To this end, for example, to fulfill transmission of the request data from point A to point B, the first routing zone 204A may have a latency of 10 μs, while the second routing zone 204B may have a latency of 50 μs. A manner in which the computer system 202 generates the user-specific routing data 202A is described in detail in conjunction with, for example, FIG. 2, FIG. 3A, FIG. 3B, and FIG. 4.

At 530, transmission data is generated. In an example, the computer system 202 is configured to generate the transmission data 508A for the routing operation based on the validation data, the user-specific routing data 202A, and the request data 510. In an example, the computer system 202 is configured to validate the user-specific routing data 202A. Once the user-specific routing data 202A is successfully validated by the user 210 as indicated by the validation data, the transmission data 508A is generated. The transmission data 508A may include the user-specific routing data 202A and the request data 510. Details associated with the generation of the transmission data 508A is described in conjunction with, for example, FIG. 5A and FIG. 5B.

In an embodiment, the computer system 202 may automate the process of transmitting the transmission data 508A, for example, without the validation of the user-specific routing data 202A. In case the latency associated with an identified specific routing zone is less than a workload threshold associated with the user-preference data 206A, the computer system 202 may transmit the transmission data 508A to the routing entity 522 without a need for validation of the identified specific routing zone or the user-specific routing data.

At 532, the transmission data is transmitted. In an example, the transmission data 508A is transmitted from the computer system 202 to the routing entity 522.

At 534, a routing operation is executed. In an example, the routing entity 522 is configured to execute the routing operation for the transmission of the message data to the destination. In an example, the computer system 202 is configured to control the routing entity 522 to execute the routing operation based on the transmitted transmission data 508A. The routing operation is executed to transmit the message data to the destination based on the user-specific routing data 202A.

To this end, the routing entity 522 is configured to identify the destination for the routing operation. The identification of the destination for the routing operation is based on the transmitted transmission data 508A. The user-specific routing data 202A identified from the transmission data 508A includes the specific sustainable routing policy identified for performing the routing operation. Based on the specific sustainable routing policy, the routing entity 522 may identify a routing path for performing the routing operation. For example, based on the specific sustainable routing policy, the routing entity 522 may identify the routing path on which data packets associated with the message data may be transmitted. Further, the message data is transmitted to the destination for processing the user request.

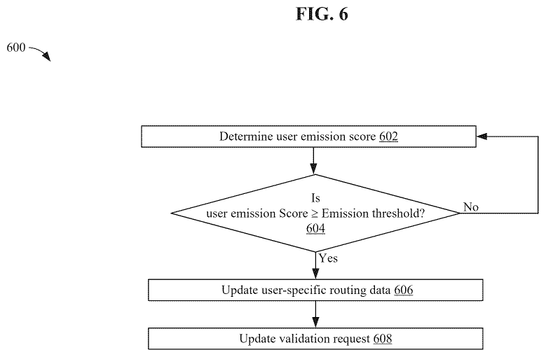

It may be noted that the computer system 202 is configured to encourage the use of sustainable routing zones by continuously monitoring user preferences (such as sustainable routing vs unsustainable routing), user activity (such as bandwidth consumption, data consumption, and the like), and overall user emission score (such as carbon emissions due to activity of the network). Based on the monitoring, the computer system 202 is configured to incentivize users who opt for sustainable routing and/or penalize users who opt for unsustainable routing. A manner in which the computer system 202 is configured to encourage the use of sustainable routing zones is described in detail in conjunction with, for example, FIG. 6.

FIG. 6 is a diagram that illustrates a flowchart 600 of a method for updating validation request, in accordance with an embodiment of the disclosure. FIG. 6 is explained in conjunction with elements from FIG. 1, FIG. 2, FIG. 3A, FIG. 3B, FIG. 4, FIG. 5A, FIG. 5B and FIG. 5C. With reference to FIG. 6, operations of the flowchart 600 may start at 602.

At 602, a user emission score is determined. In an example, the computer system 202 may be configured to determine the user emission score associated with the execution of the routing operation. The user emission score may be a quantitative metric that evaluates a total amount of greenhouse gas emissions produced by a specific entity, product, or activity over a defined period, typically expressed in metric tons of carbon dioxide equivalent (CO₂e). With reference to the present disclosure, the user emission score is indicative of an environmental impact associated with the execution of the routing operation based on the user-preference data 206A and/or the validation data specified by the user 210.

In an exemplary scenario, the user 210 is using an application that corresponds to an e-commerce application. The user 210 is interacting with the application in an interaction session for performing an operation of ordering a product, such as a pair of shoes. Pursuant to the present example, before or during, or at the start of the interaction session, the user 210 provides the user-preference data 206A indicating the sustainable routing condition data. In other words, the user-preference data 206A may indicate the user's consent for using sustainable routing zones or policies during the interaction session with the application.

Further, based on the user-preference data 206A, the computer system 202 determines the user-specific routing data 202A. The user-specific routing data 202A indicates a specific sustainable routing policy and/or a sustainable routing zone of the one or more routing zones 204 based on which the data packets are to be transmitted to the destination. Further, based on the execution of the routing operation based on the user-specific routing data 202A, the user emission score associated with the routing operation is determined. The computer system 202 may determine the grams of amount of CO₂e contributed by the routing operation associated with routing operation during the interaction session. In an example, the computer system 202 may determine that the routing operation may contribute to 2 grams of CO₂e.

In an exemplary scenario, the computer system 202 may determine a combined emission score associated with one or more interaction sessions of the user 210 with one or more applications via the user device 208. In this regard, the combined emission score may be associated with more than one routing operation. In an example, multiple interaction sessions may include the user 210 viewing product details, scrolling through customer reviews, viewing images of the product, performing various cart or wish list related operations, and placing the order. In an alternate example, multiple interaction sessions may include the user 210 interacting with multiple applications over a period of time.

At 604, a determination is made to determine whether the user emission score is greater than or equal to an emission threshold. In an embodiment, the computer system 202 may compare the determined user emission score with the emission threshold. Based on the comparison, the computer system 202 determines whether the user emission score is greater than or equal to the emission threshold or not.

In an example, if the computer system 202 determines that the user emission score is less than the emission threshold, the operations of the flowchart 600 may go back to 602. Accordingly, the computer system 202 may continue to monitor user activity to determine the emission score of the user 210.

In an example, based on the determination that the user emission score is less than the emission threshold, the computer system 202 may reward or incentivize the user 210 for their efforts toward sustainable routing and reducing the environmental impact due to energy consumption and carbon emission. The reward for the user 210 may be for encouraging the user 210 for their consistent effort in reducing the carbon footprint.

In an example, the emission threshold may be a value that corresponds to an acceptable limit associated with the emission score. In an example, the emission threshold corresponds to 10 grams of CO₂e. Further, the computer system 202 may compare the user emission score of 2 grams of CO₂e with the emission threshold of 10 grams of CO₂e.

Further, based on the determination that the user emission score is greater than or equal to the emission threshold, the operations of the flowchart 600 may move to 606.

At 606, user-specific routing data is updated. In an example, the computer system 202 is configured to update the user-specific routing data 202A based on the determination that the user emission score is greater than or equal to the emission threshold. In an embodiment, the computer system 202 updates the user-specific routing data 202A to generate updated-specific routing data. The updated-specific routing data may indicate sustainable routing zones or policies to encourage the use of sustainable routing by the user 210 for their current and/or future routing operations. In an embodiment, the computer system 202 iteratively compares the user emission score with the emission threshold during the interaction sessions to update the user-specific routing data 202A.

At 608, the validation request is updated. In an example, the computer system 202 may be configured to update the validation request for a validation of the updated user-specific routing data. In an embodiment, the computer system 202, upon generation of the updated user-specific routing data updates the validation request to be transmitted to the user device 208 associated with the user 210. The updated validation request includes the updated user-specific routing data 202A. The updated validation request is transmitted to the user device 208 for validation. In certain cases, the updated validation request may include penalty information associated with the routing operations performed by the user 210.

Further, based on the updated validation request, the computer system 202 receives updated validation data from the user 210. The computer system 202 may be configured to generate the transmission data for performing routing operation based on the updated validation data. Details associated with the validation of the validation request are provided in conjunction with FIG. 5A, FIG. 5B, and FIG. 5C.

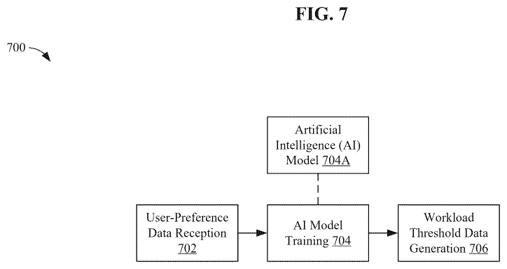

Further, in addition to the environmental impact, carbon emission, and/or energy consumption of a routing zone or a routing policy, the workload of the routing zone is to be determined to ensure reliable networking operations. Workload routing indicates methodologies for directing a routing operation among a group of target regions or routing zones according to availability, health, and activity levels of each of the target regions. In an example, the routing operation may be routed among a defined group of routing zones by selecting the routing zones that are likely to deliver the best performance when the routing operation is initiated. To this end, workload threshold indicates a threshold performance for identifying the routing zones, such as the one or more routing zones 204, that are likely to deliver the best performance. Details associated with the determination of the workload threshold for the routing operations is described in conjunction with, for example, FIG. 7.

FIG. 7 is a diagram 700 that illustrates exemplary operations for generating workload threshold data, in accordance with an embodiment of the disclosure. FIG. 7 is explained in conjunction with elements from FIG. 1, FIG. 2, FIG. 3A, FIG. 3B, FIG. 4, FIG. 5A, FIG. 5B, FIG. 5C, and FIG. 6. With reference to FIG. 7, the operations may start at 702.

At 702, a user-preference data reception operation is performed. In the user-preference data reception operation, the computer system 202 may be configured to receive the user-preference data 206A associated with the user 210. The user-preference data 206A may include the unsustainable routing condition data and/or the sustainable routing condition data. In this regard, the user-preference data 206A may indicate whether the user 210 wants to opt for sustainable routing, unsustainable routing, or a combination thereof. Further, the user-preference data 206A may be associated with the workload threshold data. In this regard, the user-preference data 206A may indicate a performance expected by the user 210 for the routing operation. The performance may be defined in terms of, for example, queueing, reliability, resource availability, time for processing, and the like.

By way of example, and not by limitation, the user-preference data 206A may include a user preferred routing zone indicating a preference of the user 210 over the sustainable routing or the unsustainable routing. The user preferred routing zone may correspond to a routing zone of the one or more routing zones 204 selected by the user. By way of example, and not by limitation, the user-preference data 206A associated with the user 210 is shown in Table 2 as given below:

TABLE 2
User-preference data

| User | Zone | Latency | Sustainability | Preferred zone |
|---|---|---|---|---|
| User | First Routing zone | 30 μs | 70% | First Routing zone |
| | Second Routing zone | 10 μs | 30% | |

In this manner, the user-preference data for a plurality of users of the computer system 202 may be received. In an example, the plurality of users may be associated with an enterprise network. In an alternate example, the plurality of users may be independent users of the computer system 202.

At 704, an artificial intelligence (AI) model training operation is performed. In the AI model training operation, the computer system 202 is configured to train an AI model 704A based on the user-preference data 206A. In an embodiment, the computer system 202 trains the AI model 704A to generate the workload threshold data for the user 210 for future routing operations as well as other users of the computer system 202.

In an embodiment, the AI model 704A corresponds to a neural network-based regression model. The neural network is a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of all nodes in the input layer may be coupled to at least one node of the hidden layer(s). Similarly, the inputs of each hidden layer are coupled to outputs of at least one node in various layers of the neural network. Outputs of each hidden layer may be coupled to inputs of at least one node in various layers of the neural network. Node(s) in the final layer may receive inputs from at least one hidden layer to output a result. The number of layers and the number of nodes in each layer may be determined from hyper-parameters of the neural network. Such hyper-parameters may be set before or while training the neural network on the training dataset. Each node of the neural network corresponds to a mathematical function (e.g., a sigmoid 2 function or a rectified linear unit) with a set of parameters, tunable during the training of the neural network. The set of parameters includes, for example, a weight parameter, a regularization parameter, and the like. Each node uses the mathematical function to compute an output based on one or more inputs from nodes in various layer(s) (e.g., previous layer(s)) of the neural network. All or some of the nodes of the neural network correspond to the same or a different mathematical function.

In the training of the AI model 704A, one or more parameters of each node of the AI model 704A may be updated based on whether an output of the final layer for a given input (from the second training dataset) matches a correct result based on a loss function for the AI model 704A. The above process may be repeated for the same or a different input until a minima of loss function may be achieved, and a training error may be minimized.

In the training of the AI model 704A, the computer system 202 provides the AI model 704A with the user-preference data 206A associated with the 210. The AI model 704A analyses the user's information, such as network details, activity, user profile data, and the like, and their corresponding preferred zone in the user-preference data 206A for the generation of the workload threshold data for the user 210.

In an embodiment of the disclosure, the computer system 202 further adjusts the one or more hyperparameters (weights and the regularization parameters) of the neural network corresponding to the AI model 704A based on a determination that an input from the set of input data matches a corresponding output in the set of output data upon the prediction. The computer system 202 repeats the adjustment of the weights and the regularization parameters until the minima of the loss function is achieved or the training error is minimized as discussed above.

In an embodiment of the disclosure, the computer system 202 stores the AI model 704A. In an alternate embodiment of the disclosure, the AI model 704A is embodied as a cloud-based service, a cloud-based application, or a cloud-based platform. Examples of the AI model 704A include one of but are not limited to, an artificial neural network (ANN), a deep neural network (DNN), a convolutional neural network (CNN), a fully connected neural network, and/or a combination of such networks.

At 706, a workload threshold data generation operation is performed. In workload threshold data generation operation, the computer system 202 is configured to generate the workload threshold data based on the trained AI model 704A. In an embodiment, the computer system 202 applies the AI model 704A to generate the workload threshold data associated with a new user request based on the user-preference data 206A. The AI model 704A analyzes the patterns and the relationships between the user 210 and their preferred zone to generate the workload threshold data.

Further, based on the workload threshold data the computer system 202 generates the user-specific routing data for the new request. The computer system 202 compares latency associated with each routing zone of the one or more routing zones or sustainability score associated with each of the one or more routing zones with the workload threshold data to identify the sustainable routing zone for the user 210. Further, based on the identified sustainable routing zone, the computer system 202 may generate user-specific routing data.

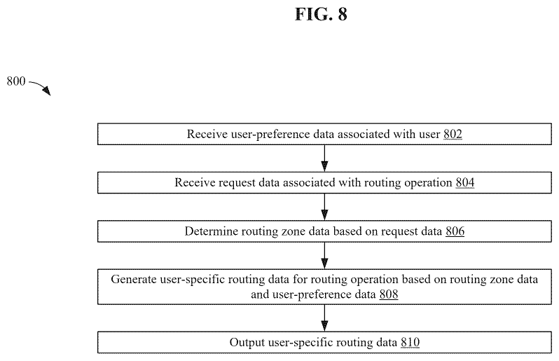

FIG. 8 is a diagram that illustrates a flowchart of an exemplary method for generation of the user-preference based user-specific routing data, in accordance with an embodiment of the disclosure. FIG. 8 is explained in conjunction with FIG. 1, FIG. 2, FIG. 3A, FIG. 3B, FIG. 4, FIG. 5A, FIG. 5B, FIG. 5C, FIG. 6, and FIG. 7. With reference to FIG. 8, there is shown a flowchart 800. The operations of the exemplary method may be performed by any computing system, for example, by the computer 102 of FIG. 1 or the computer system 202 of FIG. 2. The operations of the flowchart 800 may start at 802.

At 802, user-preference data associated with a user is received. In an embodiment, the computer system 202 is configured to receive the user-preference data 206A associated with the user 210. The user-preference data 206A indicates at least one of the sustainable routing condition data or the unsustainable routing condition data.

At 804, request data associated with a routing operation is received. In an embodiment, the computer system 202 is configured to receive the request data 510 associated with the routing operation. The request data 510 is received from the user device 208 associated with the user 210. The request data 510 includes message data for the routing operation and destination data associated with a destination of the routing operation.

At 806, routing zone data is determined based on the request data. In an embodiment, the computer system 202 is configured to determine the routing zone data based on the request data. The routing zone data indicates at least one of one or more routing zones 204 for the routing operation, latency data associated with each routing zone of the one or more routing zones 204, or sustainability score data associated with each routing zone of the one or more routing zones 204.

At 808, user-specific routing data is generated for the routing operation. In an embodiment, the computer system 202 is configured to generate the user-specific routing data 202A for the routing operation. The user-specific routing data 202A indicates at least one routing zone of the one or more routing zones 204. The user-specific routing data 202A is generated based on the routing zone data and the user-preference data 206A.

At 810, the user-specific routing data is output. In an embodiment, the computer system 202 is configured to output the user-specific routing data 202A.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable people of ordinary skill in the art to understand the embodiments disclosed herein.

What is claimed is:

1. A computer-implemented method, comprising:
receiving, by a computer, user-preference data associated with a user, wherein the user-preference data indicates at least one of sustainable routing condition data or unsustainable routing condition data;
receiving, by the computer, request data associated with a routing operation, wherein the request data is received from a user device associated with the user, and wherein the request data comprises message data for the routing operation and destination data associated with a destination of the routing operation;
determining, by the computer, routing zone data based on the request data, wherein the routing zone data indicates at least one of one or more routing zones for the routing operation, latency data associated with each routing zone of the one or more routing zones, or sustainability score data associated with each routing zone of the one or more routing zones;
generating, by the computer, user-specific routing data for the routing operation, wherein the user-specific routing data indicates at least one routing zone of the one or more routing zones, and wherein the user-specific routing data is generated based on the routing zone data and the user-preference data; and
outputting, by the computer, the user-specific routing data.

2. The computer-implemented method of claim 1, further comprising:
retrieving, by the computer, policy data associated with a plurality of routing policies;
configuring, by the computer, one or more sustainable routing policies based on the policy data and the user-preference data; and
outputting, by the computer, the one or more sustainable routing policies.

3. The computer-implemented method of claim 2, wherein the sustainable routing condition data indicates workload threshold data for a specific sustainable routing policy of the one or more sustainable routing policies.

4. The computer-implemented method of claim 3, further comprising:
analyzing, by the computer, the routing zone data based on the workload threshold data;
identifying, by the computer, a sustainable routing zone of the one or more routing zones based on the analysis, wherein the sustainable routing zone is associated with the specific sustainable routing policy; and
generating, by the computer, the user-specific routing data based on the sustainable routing zone and the specific sustainable routing policy.

5. The computer-implemented method of claim 4, wherein the analysis of the routing zone data based on the workload threshold data comprises:
comparing, by the computer, at least one of the latency data associated with each routing zone of the one or more routing zones or the sustainability score data associated with each routing zone of the one or more routing zones with the workload threshold data;
determining, by the computer, at least one of the latency data or the sustainability score data associated with the sustainable routing zone meets the workload threshold data based on the comparison; and
controlling, by the computer, an execution of the routing operation based on the determination.

6. The computer-implemented method of claim 3, further comprising:
training, by the computer, an artificial intelligence (AI) model based on the user-preference data; and
generating, by the computer, the workload threshold data based on the trained AI model.

7. The computer-implemented method of claim 1, further comprising:
generating, by the computer, a validation request for a validation of the user-specific routing data;
transmitting, by the computer, the validation request to a user device associated with the user;
receiving, by the computer, validation data based on the transmitted validation request; and
generating, by the computer, transmission data for the routing operation, wherein the generation of the transmission data is based on the validation data, and wherein the transmission data comprises the request data and the user-specific routing data.

8. The computer-implemented method of claim 7, further comprising:
transmitting, by the computer, the transmission data to a routing entity; and
controlling, by the computer, the routing entity to execute the routing operation, wherein the routing operation is executed to transmit the message data to the destination based on the user-specific routing data, and wherein the routing entity is controlled based on the transmitted transmission data.

9. The computer-implemented method of claim 8, further comprising:
determining, by the computer, a user emission score associated with the execution of the routing operation;
comparing, by the computer, the user emission score with an emission threshold;
updating, by the computer, the user-specific routing data based on the comparison of the user emission score with the emission threshold; and
updating, by the computer, the validation request for a validation of the updated user-specific routing data.

10. The computer-implemented method of claim 1, wherein each routing zone of the one or more routing zones is associated with at least one compute resource.

11. The computer-implemented method of claim 1, further comprising:
obtaining, by the computer, a first latency and a first sustainability score associated with a first routing zone of the one or more routing zones;
obtaining, by the computer, a second latency and a second sustainability score associated with a second routing zone of the one or more routing zones;
comparing, by the computer, each of the first latency with the second latency, and the first sustainability score with the second sustainability score;
identifying, by the computer, a specific routing zone from the first routing zone and the second routing zone for the routing operation, wherein the specific routing zone is identified based on the comparison and the user-preference data; and
generating, by the computer, the user-specific routing data based on the identification.

12. A computer system, comprising:
a processor set;
one or more computer-readable storage media; and
program instructions stored on the one or more computer-readable storage media, the program instructions executable by the processor set to cause the processor set to:
receive user-preference data associated with a user, wherein the user-preference data indicates at least one of sustainable routing condition data or unsustainable routing condition data;
receive request data associated with a routing operation, wherein the request data is received from a user device associated with the user, and wherein the request data comprises message data for the routing operation and destination data associated with a destination of the routing operation;
determine routing zone data based on the request data, wherein the routing zone data indicates at least one of one or more routing zones for the routing operation, latency data associated with each routing zone of the one or more routing zones, or sustainability score data associated with each routing zone of the one or more routing zones;
generate user-specific routing data for the routing operation, wherein the user-specific routing data indicates at least one routing zone of the one or more routing zones, and wherein the user-specific routing data is generated based on the routing zone data and the user-preference data; and
output the user-specific routing data.

13. The computer system of claim 12, wherein the program instructions further cause the processor set to:
retrieve policy data associated with a plurality of routing policies;
configure one or more sustainable routing policies based on the policy data and the user-preference data; and
output the one or more sustainable routing policies.

14. The computer system of claim 13, wherein the sustainable routing condition data indicates workload threshold data for a specific sustainable routing policy of the one or more sustainable routing policies.

15. The computer system of claim 14, wherein the program instructions further cause the processor set to:
analyze the routing zone data based on the workload threshold data;
identify a sustainable routing zone of the one or more routing zones based on the analysis, wherein the sustainable routing zone is associated with the specific sustainable routing policy; and
generate the user-specific routing data based on the sustainable routing zone and the specific sustainable routing policy.

16. The computer system of claim 15, wherein for the analysis of the routing zone data based on the workload threshold data, the program instructions cause the processor set to:
compare at least one of the latency data associated with each zone of the one or more routing zones or the sustainability score data associated with each zone of the one or more routing zones with the workload threshold data;
determine at least one of the latency data or the sustainability score data associated with the sustainable routing zone meets the workload threshold data based on the comparison; and
control an execution of the routing operation based on the determination.

17. The computer system of claim 14, wherein the program instructions further cause the processor set to:
train an artificial intelligence (AI) model based on the user-preference data; and
generate the workload threshold data based on the trained AI model.

18. The computer system of claim 12, wherein the program instructions further cause the processor set to:
generate a validation request for a validation of the user-specific routing data;
transmit the validation request to a user device associated with the user;
receive validation data in response to the validation request; and
generate transmission data for the routing operation, wherein the generation of the transmission data is based on the validation data, and wherein the transmission data comprises the request data and the user-specific routing data.

19. The computer system of claim 18, wherein the program instructions further cause the processor set to:
transmit the transmission data to a routing entity; and
control the routing entity to execute the routing operation, wherein the routing operation is executed to transmit the message data to the destination based on the user-specific routing data, and wherein the routing entity is controlled based on the transmitted transmission data.

20. A computer program product for generation of user-specific routing data, the computer program product comprising:
one or more computer-readable storage media; and
program instructions stored on the one or more computer-readable storage media to perform operations comprising:
receiving user-preference data associated with a user, wherein the user-preference data indicates at least one of sustainable routing condition data or unsustainable routing condition data;
receiving request data associated with a routing operation, wherein the request data is received from a user device associated with the user, and wherein the request data comprises message data for the routing operation and destination data associated with a destination of the routing operation;
determining routing zone data based on the request data, wherein the routing zone data indicates at least one of one or more routing zones for the routing operation, latency data associated with each routing zone of the one or more routing zones, or sustainability score data associated with each routing zone of the one or more routing zones;
generating user-specific routing data for the routing operation, wherein the user-specific routing data indicates at least one routing zone of the one or more routing zones, and wherein the user-specific routing data is generated based on the routing zone data and the user-preference data; and
outputting the user-specific routing data.
